(19) United States
(12) Patent Application Publication
(10) Pub. No.: US 2017/0039235 A1
(43) Pub. Date: Feb. 9, 2017

(54) AIR QUALITY METROLOGY SYSTEM

(71) Applicant: BULL SAS, Les Clayes Sous Bois (FR)

(72) Inventors: Samia BENRACHI, Chatenay Malabry (FR); Jean-Charles MASSE, Magny Les Hameaux (FR); Pascal CONRATH, Boulogne Billancourt (FR); Vincent DECHANDON, Fontenay-le-Fleury (FR)

(73) Assignee: BULL SAS, Les Clayes Sous Bois (FR)

(21) Appl. No.: 15/304,572

(22) PCT Filed: Apr. 9, 2015
(86) PCT No.: PCT/FR2015/050955

§ 371 Date: Oct. 17, 2016

(30) Foreign Application Priority Data
Apr. 17, 2014 (FR) 14 53498

(51) Int. Cl. G06F 17/30; G06Q 30/02

(52) U.S. Cl. CPC G06F 17/30371; G06F 17/30303; G06F 17/30563; G06F 17/30864; G06Q 30/0202

(57) ABSTRACT

Metrology system (2) for the management of observation data, this system being configured to collect at least one observation datum and to associate with this observation datum a quality code reflecting the usability of the observation datum with respect to a predefined quality criterion. The system includes a data acquisition module (21); a centralized data management module (22); a data presentation and dissemination module (23); and transverse functional bricks (24) for data processing and production; for end-to-end data quality control; and for intermediation so as to urbanize the architecture and allow the exposure of services.

The invention concerns a geographical information system oriented metrology platform for managing observation data in respect of one or more parameters describing a particular phenomenon such as air quality.

The multiple activities of mankind (in particular transport, industry, agriculture, heating, waste treatment) generate and reject into the atmosphere numerous substances that may evolve through chemical reactions. These substances can generate pollution that is manifested inside and outside buildings.

Air quality can vary according to local geographical configurations and according to meteorological conditions, which have a major role in the concentration/dispersion of pollutants.

Air quality is a public health issue and European and national legislation has progressively put in place, for example:
the French law on the air and the rational use of energy of 30 Dec. 1996 that imposes obligations as to monitoring of air quality, definition of quality objectives and informing the public;
the French legal obligations relating to air quality indices (July 2004), alert thresholds (October 2010) and particles smaller than 10 microns (2012).

Observation, forecasting and description means are deployed in various geographical areas in order to make possible an objective characterization of air quality.

However, in the face of continuously evolving regulations (for example managing pollutants such as chromium VI, phytosanitary products, new indicators, new action plans, increased reporting frequency), the existing solutions have more than one limitation, such as technological obsolescence, incomplete documentation or needing many manual operations to overcome their shortcomings.

An object of the invention is to propose a service platform capable of addressing these new issues.

Another object of the invention is to propose a metrology platform that on the one hand valorizes the history of the data collected by the approved organizations and on the other hand makes it possible to report quality information at European and consumer level.

In other words, an object of the invention is to propose a platform that makes it possible to refer back to this history whilst being able to collect new measurements continuously in an unstructured database making it possible, in a geographical information system, to address present-day and future consolidation requirements.

Another object of the invention is to propose a metrology platform that provides elasticity for performance aspects linked to the network of sensors for measuring the parameters to be observed.

Another object of the invention is to propose a metrology platform that anticipates foreseeable evolution of the regulations and employs a service platform capable of addressing new issues.

Another object of the invention is to develop and to host a “Big Data” solution enabling automatic storage, analysis, consolidation and dissemination of data from pollution sensors deployed in various geographical areas.

Another object of the invention is to propose a system structured on the basis of a data reference entity hosting reference data for the discipline of air quality, this reference entity making it possible to centralize this data and to limit data redundancy.

Another object of the invention is to propose a metrology platform making possible data quality control, notably making it possible to deploy checks on the quality of the collected data and making it possible to supply the quality of each datum as a characteristic associated with that datum.

Another object of the invention is to propose a metrology system that is interoperable in respect of all data and services that are to be shared, taking account of most of the technology standards and the European regulatory texts relating to the observed data.

Another object of the invention is to propose a metrology system having a technical design and architecture enabling a level of availability and of performance matched to the quality of service expectations of producers and users.

Another object of the invention is to propose a metrology system able to evolve to allow with minimum impact on the architecture employed the addition of a module, new data sets or a function.

To these ends, according to first aspect, the invention relates to a metrology system for the management of observation data, this system being configured to collect at least one observation datum and to associate with this observation datum a quality code reflecting the usability of this observation datum with respect to a predefined quality criterion, this system comprising:
a data acquisition module;
a centralized data management module;
a data presentation and dissemination module; and
transverse functional bricks:
   for data processing and production;
   for end-to-end data quality control;
   for intermediation so as to urbanize the architecture and allow the exposure of services.

The quality criterion is advantageously chosen from the list of the following criteria: the non-redundancy of the observation datum, the consistency of the observation datum according to at least one predefined rule, the integrity of the observation datum.

The system is advantageously configured to trigger an alert following a comparison of the quality code to a predefined alert threshold.

According to a second aspect, the invention relates to a metrology system of the above type for the management of observation data and geographical air quality information, the data acquisition module comprising data receiving means, a data archiving unit and a data extraction and transformation tool.

Various embodiments of the system have the following features, where appropriate in combination:
the data presentation and dissemination module includes means for consultation via a human-machine interface,
the data presentation and dissemination module generates reports in the XML format,
the data presentation and dissemination module includes means for the automatic export of data,
the data extraction and transformation tool is a code generator, a specific code being generated for each data integration process,
the data extraction and transformation tool uses a graphical interface based on Eclipse RCP,
the data presentation and dissemination module includes an orchestrator and indexing search engine.

Other objects and advantages of the invention will become apparent in the light of the description of embodiments given hereinafter with reference to the appended drawings, in which:

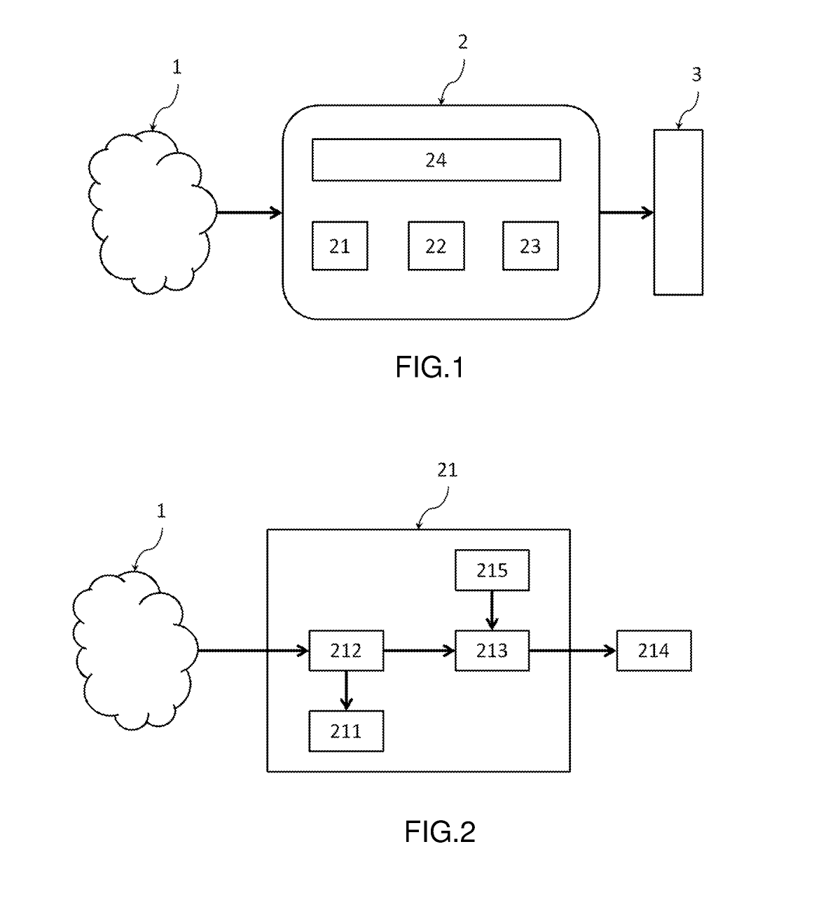

FIG. 1 illustrates a metrology platform;

FIG. 2 illustrates a module of one embodiment of a metrology system.

In FIG. 1 is shown a metrology platform comprising data sources 1, a geographical information system (GIS) oriented metrology system 2 and services 3 rendered by the metrology system 2.

The data sources 1 comprise data collection networks distributed across various geographical sites. The data includes raw data from sensors (automatic continuous or one-off measurements), samples taken manually and analyzed in the laboratory and/or validated measurements produced by a process for validating the raw data.

The services 3 rendered by the metrology system 2 include formatting the data produced by the metrology system 2 in various ways (for example tables, reports, graphs) on geographical maps in order to facilitate the exploitation of this data by professionals in this discipline, for example by way of a spatial analysis of air quality. To this end, the metrology system 2 offers the possibility of interfacing with third party systems and portals and integrates a human-machine interface (HMI) so that producers and users in the discipline and partner systems can access information on air quality (for example collected, generated or reference data). The metrology system 2 can also interface with a consumer web portal (for example www.icsqa.org) so that the public can also obtain information on air quality.

In the field of air quality, the partner systems include for example regional modeling tools needing data produced by the metrology system 2 to execute their own processes.

The metrology system 2 has the functions of:
contextualizing measurements supplied by or recovered from the data sources 1: defining context data qualifying the measurement such as sampling point, site, geographical coordinates or the pollutant under observation. This definition is stored in a so-called reference database;
storing measurements: collecting then storing raw measurement data and data validated by approved air quality monitoring laboratories supplying measurements taken in the field (for example, in France these are the Associations Agréées Surveillance Qualité de l'Air (AASQA)). This data may be verified afterwards (verification of the context of the measurement: sampling point, site, geographical coordinates, pollutant, for example) and then stored in a database (for example NoSQL Big Data);
calculating statistical data: to produce statistical data for each site (average, daily, annual concentrations of pollutants) and indicators of the impact of atmospheric pollutants;
verifying the conformity of the data: to be sure of compliance with and to be informed of departures from regulatory obligations, for example as set by European Community directive 2008/50/EC appendices 3 and 5;
disseminating data: making relevant data from the system available to air quality monitoring professionals and the public;
supervising the installed base of measuring devices, i.e. all of the geographical sites where the parameters under observation are measured, making available to system operators management information systems informing them of alerts regarding integration of measurement data and reference data.

Here, the data in the metrology system 2 comprises;
reference data: this is the most stable data, which has a long life cycle and to which the operational data makes reference. This reference data includes data describing the air quality (for example measuring stations, measuring methods, pollutants, measuring instruments), lists of data in the air quality discipline (for example station typology, typology of monitoring areas), and external administrative data (for example official geographical code, external references);
measurement data or primary data: data measured by approved laboratories using capture or acquisition systems and transmitted to the national system. In other words, measurement data input to the national system is considered primary data;
generated data, also known as statistical data: data calculated from measurement data with the aim of supplying regulatory indicators and data and making it possible to qualify air quality. This statistical data includes for example the (hourly, daily, annual) average concentrations, the number of violations of limit values or target values, indicators qualifying the impact of atmospheric pollutants such as the mean exposure index (MEI), air quality indices (e.g. in France the index IQA of the ATMO).

In fact, the metrology system 2 is configured to collect data and to centralize the collection of data (various measurements and samples). It is also configured to produce statistical data following processing of the collected data in accordance with organizational, regulatory and geographical criteria, whilst taking reference data into account.

The metrology system 2 collects any type of measurement either directly from sensors, probes, objects or from various existing databases. It is in particular capable of processing a large amount of “Big Data”, data grouped into files, structured or unstructured data.

The metrology system 2 processes the diverse collected data to transform it into a single open data model. It is to be noted that throughout this processing the metrology system 2 offers end to end collected data quality control (consistency, integrity, processing of the data). There follows making available to professionals, partners and users in the discipline a consistent and reliable observation agreeing with the regulatory directives, notably where regulatory reporting activities, managing the installed base of measuring devices and managing alerts are concerned.

The execution of a report comprises the production of data according to a data scheme and a format (for example XML) that are predefined and the transmission of that data via an electronic reporting tool.

It is to be noted that each raw or validated measurement datum features a datum quality code (or datum validity) that reflects (or specifies) the usability of the datum (for example non-redundancy, consistency, integrity). The expression datum status is also used. Equally, management rules make it possible to qualify the quality code of the datum generated, which is assigned by the data producer, as a function of the quality codes of the primary data used for the computation.

To this end, the metrology system 2 comprises:
a data acquisition (or collection) module 21;
a centralized data management module 22;
a data presentation and dissemination module 23; and
transverse functional bricks 24:
   for data processing and production (air quality statistics, activities);
   for end-to-end data quality control (consistency, conformity, duplication, for example);
   for intermediation (ESB) so as to urbanize the architecture and allow the exposure of services.

The data presentation and dissemination module 23 includes:
a human-machine interface (HMI) providing professionals in the discipline with access for managing approvals and security, for example to prohibit unauthorized modification of the datum;
APIs to enable integration of third party systems such as the PREV'AIR system (forecasting and monitoring of air quality in France and in Europe) or (regional or third party) modeling tools for data consultation and dissemination of the results of air quality studies;
interfaces with consumer web portals (for example www.icsqa.org) for consultation of consumer information;
a geographical information system to enable spatial analysis of air quality.

Referring to FIG. 2, the data acquisition module 21 includes data receiving means 212, a data archive unit 211 for storing raw data for pre-processing, and a data extraction and transformation tool 213 (for example of ETL: Extract, Transform, Load type) to render the raw data usable by the metrology system 2 (converting data into the form of collections that correspond to a chosen database).

The data extraction and transformation (ETL) tool 213 is responsible for extracting recent data: raw measurements that are automatic, manual or validated by approved organizations such as the Associations Agréées Surveillance Qualité de l'Air—AASQA. This data extraction and transformation (ETL) tool 213 then pushes the extracted and transformed data to the various modules of the layers of the centralized data management module 22 for use by the data presentation and dissemination module 23.

The data receiving means 212 for the data extraction and transformation (ETL) tool 213 make it possible to establish the connection with the data sources 1 of the approved laboratory mediations. The data sources 1 may be files of various types or Web Services made available by application software (for example CRM, ERP, eCommerce), Data Depositories, Data Marts. The protocols for transmission between the data sources 1 and the data extraction and transformation tool 213 are of FTP, HTTP, SOAP, SCP, JDBC type and other database-oriented protocols.

The data receiving means 212 may use a number of data acquisition modes:
uploading files directly from a management portal;
direct connection to a shared directory (FTP, HTTP);
direct connection to the data sources 1 via a customization process.

On each acquisition of a datum the quality thereof is verified to be sure of the integrity, conformity, consistency of the datum. These checks and verifications may be automated, manual (necessitating verification by a professional in the discipline). A data set may equally be described by a set of metadata. A number of metadata formats are supported including DCAT (Data Catalog Vocabulary) and INSPIRE (INfrastructure for SPatial InfoRmation in Europe).

The data receiving means 212 store the raw data in a legal archiving unit 211 in order to have, in the first instance, “input data without processing”. This data is a copy of the data supplied by the approved laboratories supplying air quality measurements. The source data is then processed by the data extraction and transformation (ETL) tool 213 and thus transformed into a collection 214 (for example, a collection of measurements). The data extraction and transformation (ETL) tool 213 checks the format, syntax and enrichment of the data (geocoding for example, for re-use of the data). Thus the ETL tool 213 supplies a unified data model at the exit from this process. The ESB (Enterprise Service Bus) 215 controls the ETL 213 for the purposes of these tasks.

All the data fed into the collection 214 by the ETL passes into a “Quality control” module 24 of the transverse functional bricks. This quality control module determines the validation status of the datum.

Firstly, a datum passes into the validation process. A test is then effected to determine if that datum is valid or not.

If the data is invalidated by the validation process of the “Quality control” module, the data is sent to a “correction” collection. That collection makes it possible to centralize all the data that has been invalidated, is relatively inconsistent or is awaiting later validation.

If the validation process of the “Quality control” module deems the datum to be valid (automatic or manual validation), that datum is identified as such and passes into a collection comprising the “validated” data. If the validation process of the “Quality control” module determines that the datum is invalid/inconsistent, that datum is sent to the correction process of the “Quality control” module in the “correction” collection.

The quality criteria against which data quality control is effected (i.e. according to which a quality code is associated with an observation datum) may be as follows:
uniqueness (non-redundancy): datum measured by counting duplicates relative to the total amount of data;
completeness: datum measured by the number of fields filled in relative to the total number of fields for a datum. The obligatory fields impose a minimum completeness level;
consistency: datum measured according to consistency rules defined for the object concerned, for example verification that the end date is after the start date, verification that the location of a site is actually situated in the commune to which the site belongs;
exactness: datum measured against lists or references (common codes, pollutant codes for example), for example verification that the identifier of the commune is an existing identifier;
conformity: datum measured against naming rules (for example, codification of the measurement sites) or data format;
integrity: datum measured against relations between objects, for example verification that the measuring site associated with the series of measurements is actually referenced in the metrology system.

Based on a categorization of the quality control procedures according to these criteria, a quality monitoring table includes the quality level for each of the criteria used, for each type of datum and for each datum. This table will therefore make it possible to identify data that requires an effort to be made in order to improve the quality of the data.

The correction may be effected automatically or manually. Once it has been effected, the corrected datum passes into the “Quality control” validation process. This mechanism makes it possible to check the validity of the datum upstream and downstream of its correction. If the datum passes the validity test then it is identified as modified in the collection and the history of the modifications of the datum is inserted in the collection. The datum can then be eliminated from the “correction” collection in order to optimize the space available in the base. An orchestrator referred to as “Business Process Management” (BPM) controls the ETL tool 213 and manages the tasks linked to these processes.

In the process for generating and validating statistical data, the “Data production” module seeks data in the “validated measurements” collection. Using these measurements, algorithms compute statistics that are then stored in the statistics collection. The statistical data generated passes into the “Quality control” module for validation of the data. If the statistical data generated is validated then it passes into the so-called “statistics” collection. If the data is invalidated, then the correction process described above is applied.

The transverse functional bricks 24 advantageously make possible datum quality control, data processing and production (discipline activities) and

ESB (Enterprise Service Bus) intermediation.

End to end datum quality control is a function transverse to the metrology system 2 that makes it possible to guarantee and to assure end to end datum quality control functions.

Datum quality control (the transverse function described above) makes it possible to monitor the life cycle of the datum, to place the datum in the history, to control the consistency of the datum, namely the synchronization, conformity, integrity and completeness of the files. Quality control reports are made available to the professionals relevant to a datum, notably in the activities within the discipline of managing an installed base of measuring devices or of calibration (modification of datum or missing datum) or at the level of reporting activities (verification of data).

The life cycle of the datum (raw, validated, subsequent validation) is monitored using, inter alia, the logs of the data extraction and transformation tool 213, the process of (manual or automatic) validation of the data. On exit, this data is “identified as validated” in a database (preferably MongoDB) of the centralized data management module 22 and constitutes the reference operational collection.

In the same manner, if a datum is detected as erroneous or missing, it will be integrated into the correction collection in order to be processed. On exit, this datum will be identified as corrected. The changes (modifications of the datum: the user who modified the datum, the old value, for example) are then stored in the history in order to track the evolution of the datum.

The output streams of the metrology system 2 come from the centralized module 22 for managing data in the operational collection 214 (for example, validated references/statistics/measurement collections and “correction” collections) going to the data presentation and dissemination module 23, namely:
output of the datum on a geographical map;
consultation of operational data via the HMI;
generation of reports in the XML format;
automatic export to third party partners (such as the PREV'AIR system or the AEE (Agence européenne pour l'environnement));
consultation of raw data from the history base.

The quality control process is also available at the data output level (data modification, validation, correction).

As a function of their previously defined rights users can via the HMI access GIS, consultation, management, reporting functions. Depending on the HMI module chosen, specific collections (contained in the overall set of collections) are contributed by the metrology system 2.

If the approved laboratories retransmit a datum already transmitted (revalidation process), the retransmitted datum will also be stored in an archive unit 211 and will then replace the datum initially received.

The metrology system 2 advantageously supports numerous native structured data formats (such as CSV, XLS, ShapeFile, GTFS). It is equally possible to integrate specific formats via a customization process.

The data extraction and transformation tool 213 is of “code generator” type. A specific code is generated for each data integration process and may be in Java or Perl. The data processed and the processing effected are therefore intimately connected. A graphical interface based on Eclipse RCP is used, which enables the creation of data manipulation processes. It offers a very wide palette of connectors:
application software (ERP, CRM for example), databases, central servers, files or Web Services to cover the increasing disparity of sources;
data depository, data mart, OLAP (Online Analytical Processing) applications for analysis, reporting, dashboard or scorecard, for example;
advanced ETL components stored locally, including manipulation of chains such as slowly evolving dimensions, automatic processing of references, bulk load support.

The connectors of the data extraction and transformation tool 213 cover the main SGBD (Oracle, DB2, MS SQL Server, PostgreSQL, MySQL) as well as the processing of all flat file types (CSV, Excel, XML), both in read mode and in write mode. The data extraction and transformation tool 213 facilitates the construction of requests in the databases by detecting the scheme and the relations between tables.

The centralized data management module 22 includes a database. A “MongoDB” technology database advantageously makes it possible to avoid major upgrades to the database in order to modify or add parameters. The database enables manipulation of objects structured in the JSON format for binary (documentary BSON), with no predetermined scheme. In concrete terms the data takes the form of documents stored in collections 214, and so a collection can contain any amount of data. This database can store both collected and generated measurements and also reference type data (territorial, instrumentation, monitoring device and pollutants). This therefore results in at least four collections 214: measurements, statistics, references and corrections, together with their associated data models. For rich data models it is possible to implement advanced search/navigation functions in this database, such as geographical searching, full-text criteria, numerical criteria, navigation via facets.

For simpler data models, it will be possible to use as many fields as necessary:
numeric fields enabling storage of index values (for example NO2, O3),
“timestamp” field,
text (comment) field,
fields allowing the link with the references.

The fields making the link with the models make possible a crossed search between the reference elements and the collected data elements.

The centralized data management module 22 further includes a workflow engine. This workflow engine is a “Business Process Management” (BPM) orchestrator making it possible to monitor processes triggered by internal and external events (discipline professionals, sensor events) and to orchestrate the actions to be taken. The BPM provides an administration layer at the process level and enables supervision of the correct behavior of the processes of the entire metrology system. The workflows may be used:
to integrate data “supplied” by the acquisition layer;
to “push” updating actions toward external systems for synchronizing data;
to recover complementary data in systems external to the solution;
to trigger alarms or notifications to front office applications as a function of pre-configured discipline rules;
to apply data processing discipline rules.

The workflow and the discipline rules are configurable and provide native functions such as complex processing based on the application of configurable discipline rules capable of handling serialized exchanges, in parallel with external systems, a sequencer/scheduler, or role-based security.

Moreover, the centralized data management module 22 includes an indexing engine for searching, consultation and filtering of various kinds. This indexing engine makes it possible to index data and documents in order to be able to retrieve them rapidly in the event of a search. In the data presentation layer, this engine makes it possible to feed equally well a human-machine interface (HMI) or an API for tools, or portals for example. The indexing engine favors distributed extraction, transformation and enrichment of structured or unstructured raw data, up to the provision of search services accessible from an XML/HTTP API. It provides the base allowing the deployment of all types of search applications: transverse search applications, computer watch, discipline or decision applications.

The synchronization between the different data sources 1 (for example those of the AASQA and those of the national system) is handled by the notification functions (data integration) of the extraction and transformation (ETL) tool 213 and the MongoDB database of the centralized data management module 22. Completeness checks (by station, by day) are handled by the data extraction and transformation (ETL) tool 213 and the centralized data management module 22. Finally, functions for reporting these checks are available at the level of the data extraction and transformation (ETL) tool 213 or at the MongoDB database management level.

The history of imports of external data and the result of each of these imports, consultation of the history of a reference datum are handled by the functions of the reference data management layer. The data entry and validation workflows are handled by the BPM.

The transverse functional bricks 24 include a data processing and production module. This module represents the operational activities of the discipline professionals such as: producing statistics (computing indices, rates, averages), reporting (regulatory), managing the installed base of measuring devices, managing alerts, tracking air quality monitoring programs, monitoring plans and programs, managing financial assistance. The processing and production of the data is a transverse function also calling upon a number of other modules of the metrology system 2 for the execution of these tasks, notably:
the BPM for orchestration and end to end control of the discipline processes as to the execution of those operational activities;
centralized data management to recover validated raw measurements in order to proceed to processing or producing statistical data;
the data presentation/output exposure module for exposing the data in the appropriate format.

Using the reference collection (i.e. the validated measurements), the BPM calls upon computation functions (average, index, rate for example) to establish this statistical data. Like the raw data, this data is (if necessary) subject to validation/correction before its integration into the reference operational collection.

In one embodiment the regulatory reporting is produced in a file model to the XML format (e-reporting).

The metrology system 2 advantageously incorporates management of an installed base of measuring devices, i.e. detection of non feeding of data from a measurement sensor (faulty, out of service, for example). If necessary, the metrology system 2 alerts the discipline player designated for verification. The metrology system 2 also generates a periodic report on the status of the installed base of measuring devices.

The metrology system 2 notably integrates thresholds and triggering an alert to a designated discipline player following a comparison of the quality code of a collected observation datum to a predefined alert threshold. It also generates a periodic report listing the alerts sent out.

The metrology system 2 advantageously integrates ESB (Enterprise Service

Bus) intermediation in order to urbanize the architecture and to make possible the exposure of air quality services and to interconnect the modules: acquisition, centralized data management, processing and production of data via Push/Pull mechanisms.

To integrate the presentation and the dissemination of data for discipline professionals via a simple human-machine interface (HMI), it is at the level of the workstation that there are integrated the various components necessary on the one hand for the presentation of the data and on the other hand for making decisions and carrying out the actions associated with a standard process or a particular event. The components to be integrated at the workstation level are intended for the following functions, for example:
management of approvals and associated rights according to the role and the position of each discipline player;
access to data in read or write mode;
consolidation of measurements, statistics;
implementation and execution of discipline processes (tasks/actions basket);
application integration with consolidation of information coming from partners system;
requesting and unified searching of access to information and data.

Moreover, the concepts of roles, functions and geographical assignments are taken into account in order to produce a refined model of the access rights and the privileges of the various users, thereby making it possible to model an organization.

The generic metrology platform includes a native geographical information system with storage of geographical objects. Thanks to the data processing and production layer, to the BPM (task orchestrator) and the ESB (information transport), data is transferred onto maps as it is produced, enabling the discipline player to proceed to a spatial analysis of this information.

The reference data, measurement data and computer data mostly have a geo-spatial dimension. They may be either geolocated by a point (for example station, sampling point) or represented in geographical form on a map (for example, administrative unit, ZAS zone). Thanks to the geographical information system, the metrology system 2 manages the geometrical component of each geographical datum. The geometrical component of each datum consists of:
the geometrical representation of the datum (point, line, polygon, multipolygon);
the projection in which the geometrical representation is defined.

Using this geometrical component of the data, the metrology system enables geometrical operations: cartographic superposition of data, intersection of data, inclusion of data, union of data, geographical vicinity of data, calculation of distance, calculation of area.

These operations will also make it possible to carry out checks on spatial consistency such as the inclusion of a point in a polygon (for example, to verify that a station is actually in the territory of the associated commune), or the inclusion of a polygon in another polygon.

In particular, the geographical representation is used in reporting the data to the European Commission. With each datum of a geographical nature, the system associates its geographical representation. The new ways of reporting dictated by the 2011 decision recommend transmitting the geographical coordinates of the data in the ETRS89 projection.

In order to address these reporting requirements, the metrology system offers the following functionalities:
generation of geographical objects in the GML 3.2 format;
generation of geographical objects in the shapefile format;
conversion tools between the various projections (such as ETRS89, Lambert 93, or WGS84).

It follows that the metrology system 2 described above makes it possible:
to collect and to centralize in a single database all of the data from the air quality monitoring device (measurement data, reference data);
to produce statistical data from the collected data, in accordance with organizational, regulatory and geographical criteria;
to implement data quality control over the whole of the system for processing the datum;
to guarantee consistency between data at the national level and data measured locally;
to trace the life cycle and the history of the versions and modifications associated with a measurement datum or a reference datum;
to make available to approved air quality monitoring laboratories all the air quality data that may be useful to the exercise of their activity in their monitoring territory;
to make available to government departments the data necessary for tracking air quality monitoring policy over the various geographical areas of the territory;
to make available to partners systems in the air quality discipline (e.g.: PREVAIR and regional modeling platforms) the data necessary for the execution of their processes with results that contribute to informing on air quality over the national territory;
to select, monitor, format, export and disseminate the necessary data and to carry out technical studies relating to the monitoring device;
to configure and to centralize the observation data that could be made available to the public, searchers and design offices via a common portal.

The metrology system 2 advantageously makes available to discipline users, partners and professionals data according to the INSPIRE (INfrastructure for SPatial InfoRmation in Europe) regulatory requirements, notably with regard to structuring spatial geographical information.

The various embodiments described above advantageously rely on an integration architecture that provides a broad library of functionalities and components that has the effect of:
simplifying access to applications and data;
centralizing management of rights and approvals;
supplying consolidated indicators (management information systems);
providing easy integration at lower cost;
implementing integration with the various input/output points of the system (“Interface Media Management” functions).

The metrology system described above advantageously implements data quality control throughout the datum life cycle, whether this means the measurement datum, the reference datum or the generated datum. Actually, for each operation effected on a (measurement, reference or generated) datum, the system tracks the nature of the operation (creation, modification, checking, change of version), the result of the operation, the date and the time of the operation and the user originating the operation. Moreover, it is possible to show a list of the operations effected on each datum consulted in the metrology system.

More generally, the metrology system described above makes it possible to store, analyze, consolidate, disseminate any other observation datum concerning phenomena/resources other than air quality. It follows that this metrology system is advantageously generic and can be used for the management of data from observing one or more parameters describing the weather, for example.

1. A metrology system (2) for the management of observation data, this system being configured to collect at least one observation datum and to associate with this observation datum a quality code reflecting the usability of the observation datum with respect to a predefined quality criterion, this system comprising:
a data acquisition module (21);
a centralized data management module (22);
a data presentation and dissemination module (23); and
transverse functional bricks (24):
for data processing and production;
for end-to-end data quality control of the metrology system (2);
for intermediation so as to urbanize the architecture of the metrology system (2) and allow the exposure of services.

2. The metrology system (2) as claimed in claim 1, wherein the quality criterion is chosen from the list of the following criteria: the non-redundancy of the observation datum, the consistency of the observation datum according to at least one predefined rule, the integrity of the observation datum.

3. The metrology system (2) as claimed in claim 1, configured to trigger an alert following a comparison of the quality code to a predefined alert threshold.

4. The metrology system (2) as claimed in claim 1, for the management of observation data and air quality geographical information, the data acquisition module (21) comprising data receiving means (212), a data archive unit (211) and a data extraction and transformation tool (213).

5. The metrology system (2) as claimed in claim 4, wherein the data presentation and dissemination module (23) includes means for consultation via a human-machine interface.

6. The metrology system (2) as claimed in claim 4, wherein the data presentation and dissemination module (23) generates reports in the XML format.

7. The metrology system (2) as claimed in claim 4, wherein the data presentation and dissemination module (23) includes means for the automatic export of data.

8. The metrology system (2) as claimed in claim 4, wherein the data extraction and transformation tool (213) is a code generator, a specific code being generated for each data integration process.

9. The metrology system (2) as claimed in claim 8, characterized in that the data extraction and transformation tool (213) uses a graphical interface based on Eclipse RCP.

10. The metrology system (2) as claimed in claim 4, wherein the data presentation and dissemination module (23) includes an orchestrator and indexing search engine.
